(19) United States
(12) Patent Application Publication
(10) Pub. No.: US 2023/0192211 A1
(43) Pub. Date: Jun. 22, 2023

(54) LIGHTING SYSTEM

(71) Applicant: Taur Technologies Limited, Horsham, West Sussex (GB)

(72) Inventors: Carson BROWN, Horsham, West Sussex (GB); Richard ADEY, Dorking, Surrey (GB)

(21) Appl. No.: 17/998,633

(22) PCT Filed: May 11, 2021
(86) PCT No.: PCT/GB2021/051127

§ 371 Date: Nov. 11, 2022

(30) Foreign Application Priority Data
May 12, 2020 (GB) 2006979.5

(51) Int. Cl. B62J 6/26; B62J 6/015; B62J 6/057; H05B 47/105

(52) U.S. Cl. CPC B62J 6/26; B62J 6/015; B62J 6/057; H05B 47/105; B62J 45/40

(57) ABSTRACT

A light projection system for a motorized kick scooter, comprising a light source and a controller. The light source is configured to illuminate a rider of the motorized kick scooter by projecting light onto the rider, and has at least three different light intensity states. Which of the at least three light intensity states the light source operates in is controlled by the controller, and depends on one or more properties of the motorized kick scooter.

### FIELD OF THE INVENTION

The invention relates to the field of lighting systems, and in particular to lighting systems for motorized kick scooters.

### BACKGROUND OF THE INVENTION

Motorized kick scooters are becoming an increasingly popular form of transport, particularly in busy cities, as they allow riders to move quickly through traffic, and are easier to ride and more portable than other popular single-track vehicles such as bicycles and motorcycles.

Current motorized kick scooters generally have rear-facing lighting positioned on the rear mudguard of the scooter. Since motorized kick scooters typically have relatively small-diameter wheels, the rear mudguard of a motorized kick scooter, and therefore the light source for the rear-facing lighting, is close to the ground. This means that the rear-facing lighting is not easily visible to other road users.

The poor visibility of rear-facing lighting of motorized kick scooters presents a serious risk to riders of motorized kick scooters in low-light situations, for example, at night, as it means that the scooter, and therefore the rider, cannot easily be seen by other road users. In particular, the lack of visibility of rear-facing lighting on motorized kick scooters means that other road users are not able to easily see the presence of a motorized kick scooter and its user.

Moreover, even if the other roaders are able to see the kick scooter, the lack of visibility of the rear-facing lighting increases a difficulty in identifying when the motorized kick scooter is slowing down.

A light source positioned on the rear mudguard of a motorized kick scooter becomes less visible to a vehicle following the scooter the closer the vehicle is to the rear of the scooter; such a light source therefore has particularly low visibility to a vehicle directly behind the scooter. This means that a rear-facing light (e.g. a braking light) on a motorized kick scooter cannot generally be seen by a vehicle behind the scooter.

There is therefore a need for an improved lighting system for a motorized kick scooter.

### SUMMARY OF THE INVENTION

The invention is defined by the claims.

The present disclosure proposed a light projection system for a motorized kick scooter, comprising: a light source configured to project light for illuminating a rider of the motorized kick scooter and operable in at least three different light intensity states, wherein the at least three light intensity states comprise: a first intensity state, in which the light source is configured to emit light of a first intensity; and a second intensity state, in which the light source is configured to emit light of a second, greater intensity; and a controller configured to control in which of the at least three light intensity states the light source operates based on one or more properties of the motorized kick scooter.

This light projection system projects light onto a rider of a motorized kick scooter. The rider’s body is higher and larger than a rear-facing light positioned at the rear of a motorized kick scooter, so illuminating the rider makes the rider more visible to other road users than a rear-facing light would.

The three intensity states of the light source allow the light intensity to be adjusted according to circumstances relating to the scooter’s motion, use or other user interaction. For example, the light intensity may be adjusted based on whether one or more properties of the scooter indicate that the rider is mounted and riding the scooter or that the scooter is braking.

The first intensity may be zero, so that, when operating in the first intensity state, the light source may be configured to emit no light.

In some embodiments, the one or more properties of the motorized kick scooter are properties that are responsive to a user interaction with the motorized kick scooter.

In this way, the intensity of the illumination of the rider may vary to alert other road users to any significant changes in how the scooter is being operated, such as when the rider applies the scooter’s brakes, and when the rider mounts and begins to ride the scooter.

Optionally, the one or more properties of the motorized kick scooter include at least one of: a speed; a pitch; a roll; a yaw; a braking; an acceleration; a deceleration; an inertial measurement unit status; a weight of a user on the motorized kick scooter; an on/off state; and/or information responsive to a user input for controlling a speed of the motorized kick scooter.

A user input for controlling a speed of the motorized kick scooter may be an input at a speed control system of the motorized kick scooter. For example, the user input may be a user input for activating a motor of the motorized kick scooter, such as a user pressing a throttle of the motorized kick scooter.

In some examples, the controller is configured to receive sensor data from one or more sensors that monitor the motorized kick scooter, the sensor data providing information on the one or more properties of the motorized kick scooter.

The controller may be configured to control the light source to enter the first intensity state based on an indication from the one or more properties of the motorized kick scooter that a user is not mounted on and/or riding the motorized kick scooter. This reduces the likelihood that the rider will be blinded or dazzled by the lights while the rider is in the process of mounting the scooter or is wheeling the scooter along prior to mounting the scooter.

In some examples, the one or more properties of the motorized kick scooter include an on/off state of the motorized kick scooter; the controller is configured to control the light source to enter the first intensity state in response to the motorized kick scooter being in an off state; and the controller is configured to keep the light source in the first intensity state in response to the motorized kick scooter being switched from an off state to an on state.

In this way, the light source may emit no light when the scooter is switched off, and may continue to emit no light when the scooter is first switched on.

Optionally, the one or more properties of the motorized kick scooter include information responsive to a user input for controlling a speed of the motorized kick scooter; and the controller is configured to keep the light source in the first intensity state in response to the information responsive to a user input indicating that no user input for controlling a speed of the motorized kick scooter has been received since a time at which the motorized kick scooter was most recently switched on.

By keeping the light source in the first intensity state while the information responsive to a user input indicates that no user input for controlling speed has been received in the current session, the light source will only begin emitting light once the rider starts riding the scooter. Other methods of determining whether a user is mounted on and/or riding the motorized scooter will be apparent to the skilled person. In one example, the properties of the motorized kick scooter includes a weight of a user on the motorized kick scooter, and the controller is configured to keep the light source in the zero intensity state in response to there being no weight of the user on the motorized kick scooter.

In at least one embodiment, the one or more properties of the motorized kick scooter include a speed; a braking and an acceleration of the motorized kick scooter; and the controller is configured to control the light source to enter the second intensity state in response to: the information responsive to a user input indicating that a user input for controlling the speed of the motorized kick scooter has been received since a time at which the motorized kick scooter was most recently switched on; the speed being greater than a first predetermined speed threshold; and the acceleration being greater than a first predetermined acceleration threshold; and/or no braking being applied.

This embodiment enables the rider of the scooter to be seen by other road users while the scooter is being ridden. By operating the light source in the second intensity state when the scooter is decelerating at a deceleration below a threshold, other road users are not unnecessarily alerted to slight decelerations that are not caused by a rider applying the brakes, such as a slight reduction in speed when going uphill.

In some embodiments, the one or more properties of the motorized kick scooter include information responsive to a user input for controlling a speed of the motorized kick scooter, and a speed and a braking of the motorized kick scooter; and the controller is configured to control the light source to enter the second intensity state in response to: a speed being no greater than a first predetermined speed threshold; braking being applied; and the information responsive to a user input indicating that a user input for controlling the speed of the motorized kick scooter has been received since a time at which the motorized kick scooter was most recently switched on.

This allows the rider of the scooter to remain illuminated while temporarily stationary during a journey, for example, while stopping at a traffic light.

Optionally, the at least three light intensity states comprise: a third intensity state, in which the light source is configured to emit light of a third intensity, wherein the third intensity is greater than the second intensity.

In some examples, the one or more properties of the motorized kick scooter include a speed of the motorized kick scooter, and an acceleration and/or a braking of the motorized kick scooter; the controller is configured to control the light source to enter the third intensity state in response to: a speed being greater than a first predetermined speed threshold; an acceleration being less than a second predetermined acceleration threshold and/or braking being applied.

Causing the light source to switch to a third intensity state when a rider applies the brakes or the scooter otherwise experiences a large deceleration alerts other road users to significant reductions in speed.

Optionally, the at least three light intensity states comprise: a fourth intensity state, in which the light source is configured to emit light of a fourth intensity, the fourth intensity being greater than the first intensity and lower than the second intensity.

An additional light intensity state may be used to emit low intensity light in situations where a rider of the scooter may require some light, but would be at risk of being dazzled by high intensity light, for example, between kick-starting the scooter and pressing the throttle, and when dismounting the scooter.

In some embodiments, the one or more properties of the motorized kick scooter include a speed of the motorized kick scooter and information responsive to a user input for controlling a speed of the motorized kick scooter; and the controller is configured to control the light source to enter the fourth intensity state in response to: the speed being greater than a second predetermined speed threshold; and the information responsive to a user input indicating that no user input for controlling a speed of the motorized kick scooter has been received since a time at which the motorized kick scooter was most recently switched on.

In this way, the light source may enter the fourth intensity state when the scooter has been kick-started but the rider has not yet pressed the throttle. This allows the rider to be illuminated once they have kick-started the scooter, but using a low intensity light that will not dazzle them should they need to look down to press the throttle.

In some embodiments, the one or more properties of the motorized kick scooter include information responsive to a user input for controlling a speed of the motorized kick scooter, and a speed and a braking of the motorized kick scooter; and the controller is configured to control the light source to enter the fourth intensity state in response to: the speed being no greater than a first predetermined speed threshold; no braking being applied; and the information responsive to a user input indicating that a user input for controlling a speed of the motorized kick scooter has been received since a time at which the motorized kick scooter was most recently switched on.

This means that the light source may enter the fourth intensity state when a rider of the scooter has stopped and released the brakes of the scooter, ready to dismount. This avoids the user being dazzled by the light source as they dismount the scooter.

The light projecting system may further comprise a reflector configured to reflect a portion of light emitted by the light source away from a rider of the motorized kick scooter. In this way, the beam emitted by the light source may be split, allowing part of it to illuminate a rider of the scooter and part of it to be directed away from the scooter for long range visibility.

Embodiments may comprise a motorized kick scooter comprising any herein described light projection system.

The light source is preferably positioned to illuminate a rear of a rider of the motorized kick scooter. This allows the rider to be easily visible to road users behind the scooter.

### BRIEF DESCRIPTION OF THE DRAWINGS

Examples of the invention will now be described in detail with reference to the accompanying drawings, in which:

FIG. 1 illustrates a motorized kick scooter comprising a light source of a light projection system, according to an embodiment of the invention;

FIG. 2 illustrates a light projection system for a motorized scooter, according to an embodiment of the invention;

FIG. 3 illustrates a speed-time graph of a motorized kick scooter for an example journey; and

FIG. 4 illustrates a light projection system for a motorized kick scooter, according to another embodiment of the invention.

### DETAILED DESCRIPTION OF THE EMBODIMENTS

According to a concept of the invention, there is proposed a light projection system for a motorized kick scooter, comprising a light source and a controller. The light source is configured to illuminate a rider of the motorized kick scooter by projecting light onto the rider, and has at least three different light intensity states. Which of the at least three light intensity states the light source operates in is controlled by the controller, and depends on one or more properties of the motorized kick scooter.

Embodiments are at least partly based on the realizations that the rider of the motorized kick scooter is at eye level, and is larger than a rear-facing light positioned on the rear mudguard of the scooter, and therefore that projecting light onto the rider of the scooter will make the scooter and rider more visible to other road users, and that adjusting the light intensity according to one or more properties of the scooter may alert other road users to changes in the scooter’s motion or use.

Illustrative embodiments may, for example, be employed in motorized kick scooters.

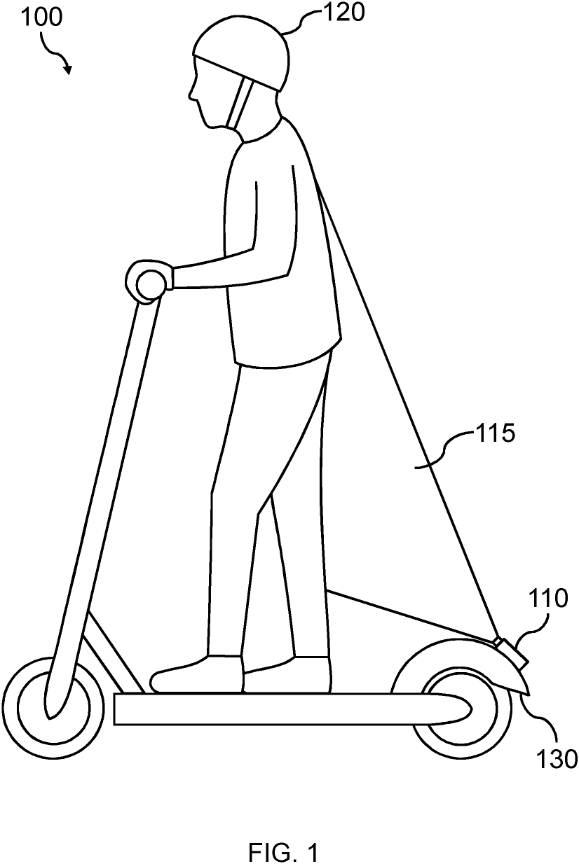

FIG. 1 illustrates a motorized kick scooter 100, comprising a light source 110 of a light projection system, according to an embodiment of the invention. The light projection system is, itself, an embodiment of the invention, and further comprises a controller, not shown in FIG. 1.

The light projection system is configured to project light 115 from the light source 110 onto a rider 120 of the motorized kick scooter 100. In FIG. 1, the light source 110 is positioned on a rear mudguard 130 of the motorized kick scooter, but the light source may be positioned anywhere on the motorized kick scooter: either behind the rider 120, in order to illuminate a rear of the rider, or in front of the rider 120, in order to illuminate a front of the rider. In embodiments in which the light source is configured to illuminate a front of the rider, the light projected from the light source may be angled to avoid illuminating an expected position of a face of the rider, in order to reduce the likelihood of projecting light into the rider’s eyes. In some embodiments, the light projection system may comprise a plurality of light sources, each of which is placed in a different position on the motorized kick scooter in order to illuminate both the front and rear of the rider.

The light source 110 may, for example, be a laser, an LED or a (halogen) bulb, and may be configured to project light 115 onto the rider 120 through one or more lenses.

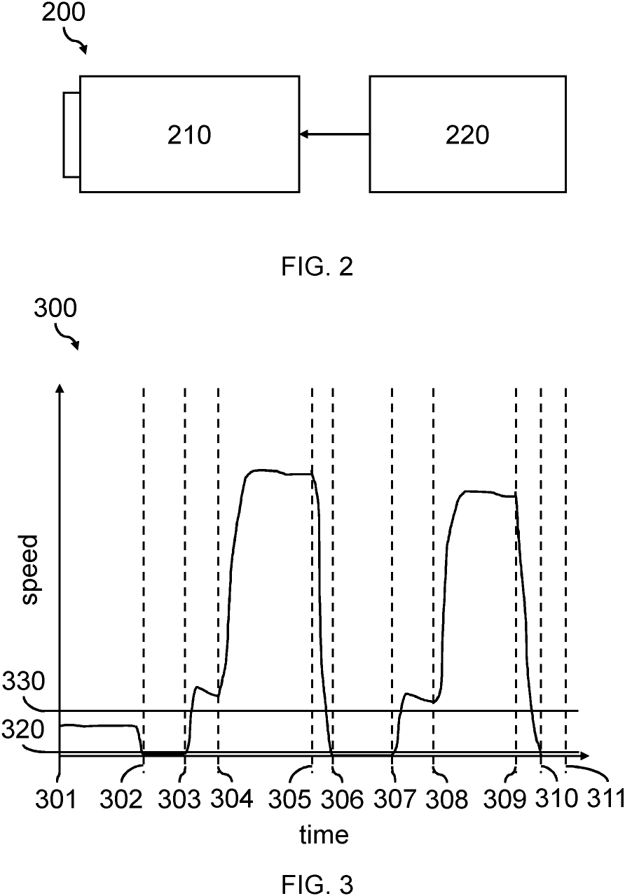

FIG. 2 illustrates a light projection system 200 for a motorized scooter, comprising a light source 210 and a controller 220, according to an embodiment of the invention.

The light source 210 may be the light source 110 of FIG. 1, and is configured to project light for illuminating a rider of a motorized kick scooter. The light intensity of the light source 210 is adjustable, the light source being operable in at least three different light intensity states.

Four different light intensity states are described in the present disclosure, although others may be used. A first light intensity state may for use when the user is not (yet) riding the motorized kick scooter (e.g. an “OFF intensity state”). A second light intensity state may be for use when the user is riding the motorized scooter conventionally, e.g. maintaining a speed or accelerating (e.g. a “normal intensity state”). A third light intensity state may be for use when the motorized scooter is braking or slowing down (e.g. a “braking intensity state”). A fourth light intensity state may be for use when the motorized scooter is temporarily stationary (e.g. in traffic) or the user is dismounting. These intensity states are only examples.

The light source is configured to be operable in at least a first and second light intensity state, as well as a third and/or fourth light intensity state.

The controller 220 is configured to control in which light intensity state the light source 210 operates based on one or more properties of the motorized kick scooter. The one or more properties of the motorized kick scooter may be properties responsive to a user interaction with the motorized kick scooter, and may include at least one of a speed, a pitch, a roll, a yaw, a braking, an acceleration, a deceleration, an inertial measurement unit (IMU) status, a weight of a user on the motorized kick scooter, an on/off state, and/or information responsive to a user input for controlling a speed of the motorized kick scooter.

The controller 220 may obtain the information required to determine a desired light intensity state for the light source 210 by receiving sensor data from one or more sensors that monitor the motorized kick scooter, wherein the sensor data provides information on the one or more properties of the motorized kick scooter. The one or more sensors may comprise at least one of a speedometer, an accelerometer, a gyroscope, a user interaction with a brake lever, a user interaction with a throttle, an inertial measurement unit, an on/off switch, a weight sensor, an infrared sensor, a capacitive handle and/or a (rider) position sensor.

By way of example only, a speedometer may provide information on a speed and/or acceleration of the motorized kick scooter. An inertial measurement unit (IMU) may provide information on an acceleration of the motorized kick scooter and/or a pitch/roll/yaw of the motorized kick scooter. Other suitable sensors and their purposes would be apparent to the skilled person.

In some embodiments, the one or more properties of the motorized kick scooter may determine only when the controller 220 controls the light source 210 to enter a different light intensity state. In other words, the controller 220 may control the light source 210 to enter one of the at least three light intensity states in response to the one or more properties of the motorized kick scooter satisfying the criterion or criteria for entering that light intensity state; the light source 210 may then remain in that light intensity state, even if the one or more properties of the motorized kick scooter change, until the one or more properties satisfy the criterion or criteria for entering a different light intensity state, at which point the controller 220 will control the light source 210 to enter the different light intensity state.

In other embodiments, the controller 220 may be configured such that a desired light intensity state is defined for every possible combination of the one or more properties of the motorized kick scooter. In other words, the one or more properties may determine whether the light source is operating in a particular light intensity state, not only when the light source may enter the particular light intensity state. This ensures that the light source is always operating in an appropriate light intensity state.

The at least three light intensity states may comprise a first intensity state, in which the light source 210 emits light of a first intensity. In some embodiments, the first intensity is an intensity of zero, so the light source 210 emits no light when operating in the first intensity state.

The controller 220 may be configured to control the light source 210 to enter the first intensity state based on an indication from the one or more properties of the motorized kick scooter that the motorized kick scooter is not currently mounted by a user and/or that the motorized kick scooter is not currently being ridden.

Light projected from the light source 210 might blind or dazzle a user of the motorized kick scooter if the user is not mounted on the scooter and facing a direction of travel of the scooter; the likelihood of this may be reduced by configuring the light source 210 to emit no light until it is determined that the user is mounted on and/or riding the motorized kick scooter, even if the light projection system is switched on.

The skilled person would be capable of using a number of different combinations of parameters to identify whether or not the motorized scooter is currently mounted by a user and/or not currently being ridden, some examples of which are hereafter described.

In particular, the controller may use information using information responsive to an ON/OFF state of the motorized scooter and/or a speed of the scooter and/or an indication of whether the throttle has been operated to determine whether or not the scooter is mounted by a user.

An indication that the motorized kick scooter is not currently mounted and/or being ridden may comprise, for example, detecting that the motorized kick scooter is switched off, or that the motorized kick scooter is switched on, but that no user input for controlling a speed of the motorized kick scooter has been received in a current session (i.e. since the motorized kick scooter was most recently switched on).

For example, the controller 220 may be configured to control the light source 210 to enter the first intensity state in response to the motorized kick scooter being in an off state. The controller 220 may be configured to keep the light source 210 in the first intensity state in response to the motorized kick scooter being switched from an off state to an on state, that is, the light source 210 will stay in the first intensity state when the motorized kick scooter is first switched on. In some embodiments, once the motorized kick scooter is switched on, the controller may be configured to keep the light source in the first light intensity state until a user input for controlling a speed of the motorized kick scooter is received, for example, until a rider of the motorized kick scooter presses or otherwise operates or interacts with a throttle of the scooter.

As another example, the controller may be configured to control the light source 210 to enter the first intensity state in response to a first predetermined period of time passing since receiving a user input (for controlling speed) and/or since the speed of the motorized kick scooter has been below a predetermined threshold. In this way, the first intensity state may be entered if the user is no longer riding the motorized scooter (e.g. but has forgotten to switch it off).

The at least three light intensity states may further comprise a second intensity state, in which the light source 210 emits light of a second intensity, greater than the first intensity.

The controller 220 may control the light source 210 to enter the second intensity state based on the one or more properties of the motorized kick scooter indicating that the motorized kick scooter is being ridden or operated in a conventional manner. The second intensity is a non-zero intensity, allowing other road users to see the rider and scooter when the scooter is being ridden.

The skilled person would be capable of using a number of different combinations of properties of the motorized scooter to identify whether the motorized kick scooter is being ridden or operated in a conventional manner, some examples of which are hereafter described.

In particular, identification that the motorized kick scooter is being ridden in a conventional manner may be performed using information responsive to a speed of the motorized kick scooter and/or a time since the motorized kick scooter was switched on and/or an indication of whether a user has interacted with a throttle and/or an acceleration of the kick scooter. Other suitable properties would be apparent to the skilled person.

In some embodiments, the controller 220 may control the light source 210 to enter the second intensity state based on the one or more properties of the motorized kick scooter indicating that the motorized kick scooter is being ridden but is not currently braking or otherwise decelerating rapidly, in order that other road users may be alerted to the motorized kick scooter slowing down.

An indication that the scooter is being ridden but not currently braking or otherwise decelerating rapidly may comprise, for example, detecting that a user input for controlling the speed of the motorized kick scooter has been received since a time at which the motorized kick scooter was most recently switched on (for example, that a rider of the scooter has interacted with or operated a throttle), detecting that a speed of the scooter is greater than a first predetermined speed threshold, and detecting that an acceleration of the scooter is greater than a first predetermined acceleration threshold and/or that no braking is being applied. Sensors for providing this information will be apparent to the skilled person, and may include one or more of the following: a sensor configured to monitor an interaction with a throttle, a speedometer, an accelerometer, and/or a sensor configured to monitor an interaction with a brake lever.

In some embodiments, the first predetermined speed threshold may be zero, or close to zero. In this way, once a rider of the motorized kick scooter has pressed (or otherwise operated) a throttle, any non-zero speed of the scooter may result in the light source 210 operating in the second intensity state, providing (e.g. if there is a third intensity state) the acceleration of the scooter is above the first predetermined acceleration threshold (and/or that no braking is being applied).

The first predetermined acceleration threshold may be negative (e.g. between -8 and 0 km/h), such that any positive acceleration or zero acceleration is determined to be greater than the first predetermined threshold, and any negative acceleration with a magnitude smaller than the magnitude of the first predetermined acceleration threshold is determined to be greater than the first predetermined acceleration threshold. In this way, the controller 220 may configure the light source 210 to operate in the second intensity state when the motorized kick scooter is traveling at a constant speed, accelerating (with a positive acceleration) or decelerating slightly without braking, due, for example, to natural variations in speed while going up a slight incline.

As another example, the controller may be configured to cause the light source to enter the second intensity state in response to the speed being above a predetermined value (e.g. above 8 km/h), and (e.g. if there is a third intensity state) detecting that an acceleration of the scooter is greater than a first predetermined threshold and/or that no braking is applied. The predetermined value may be selected to represent a speed above an (average) walking speed of a person, to indicate that the scooter is being ridden (rather than pushed along).

In some embodiments, the controller 220 may use further properties of the motorized kick scooter to determine whether to control the light source 210 to enter the second intensity state, such as a pitch, a roll, a yaw, an inertial measurement unit status, a weight of a user, and/or a user input for controlling a speed of the motorized kick scooter. Sensors for providing information on these properties will be apparent to the skilled person, and may include at least one or more of: an accelerometer, a gyroscope, an inertial measurement unit, a weight sensor and/or a sensor configured to monitor an interaction with a throttle.

For example, the controller 220 may control the light source 210 to enter the second intensity state in response to a combination of some or all of: the speed being greater than the first predetermined speed threshold; an acceleration being greater than the first predetermined acceleration threshold and/or no braking being applied; at least two of a non-zero pitch, a non-zero roll and/or a non-zero yaw; an inertial measurement unit status indicating that the scooter is vertical (e.g. a zero or near-zero roll); a weight of a user being present on the motorized kick scooter; and information responsive to a user input indicating that a user input for controlling the speed of the motorized kick scooter was most recently switched on. Suitable combinations of these properties for determining that the second intensity state is the desired intensity state will be apparent to the skilled person.

During a typical journey on a motorized kick scooter, the scooter may stop temporarily before continuing the journey, for example, at traffic lights or a junction. In such situations, it is desirable for a rider of the motorized kick scooter to remain illuminated, and therefore visible to other road users. The controller 220 may therefore be configured to control the light source 210 to enter the second intensity state based on the one or more properties of the motorized kick scooter indicating that the scooter is stationary but has not reached the end of its journey.

An indication that the motorized kick scooter is stationary but has not reached the end of its journey may comprise, for example, detecting that a speed of the scooter is not greater than the first predetermined speed threshold, that a braking is applied, and that a user input for controlling the speed of the motorized kick scooter has been received since a time at which the motorized kick scooter was most recently switched on.

A user input for controlling the speed of the motorized kick scooter having been received since a time at which the motorized kick scooter was most recently switched on indicates that the motorized kick scooter has already started a journey, while a braking being applied indicates that the rider is not about to dismount the scooter, that is, that the motorized kick scooter’s journey has not ended.

In some embodiments, the at least three light intensity states may further comprise a third intensity state, in which the light source 210 emits light of a third intensity, greater than the second intensity.

The controller 220 may control the light source 210 to enter the third intensity state based on the one or more properties of the motorized kick scooter indicating that the motorized kick scooter is braking (e.g. whilst moving at speed) and/or slowing down more than a predetermined amount.

An increase in brightness of the illumination of a rider of the motorized kick scooter may, in this way, be used to alert other road users to the reduction in the scooter’s speed as it brakes, allowing road users behind the motorized kick scooter to respond accordingly.

In particular, the controller may determine whether to enter the third intensity state based on information using information responsive to a speed of the motorized kick scooter, a braking of the motorized kick scooter and/or a deceleration of the motorized kick scooter.

An indication that the motorized kick scooter is braking may comprise, for example, detecting that a speed of the motorized kick scooter is greater than the first predetermined speed threshold, and that braking is applied.

There may be situations in a journey of a motorized kick scooter where the rider is not applying the brakes, but the scooter is still decelerating rapidly enough that other road users should be alerted to the reduction in the scooter’s speed, for example, when the scooter is traveling up a steep hill. The controller 220 may therefore be configured to control the light source 210 to enter the third intensity state based on the one or more properties of the motorized kick scooter indicating that the scooter is decelerating rapidly.

An indication that the motorized kick scooter is decelerating rapidly may comprise, for example, detecting that a speed of the motorized kick scooter is greater than the first predetermined speed threshold, and that an acceleration of the motorized kick scooter is less than a second predetermined acceleration threshold.

The second predetermined acceleration threshold, like the first predetermined acceleration threshold, may be negative, such that an acceleration is determined to be less that the second predetermined acceleration threshold only if the acceleration is a negative acceleration with a magnitude larger than the magnitude of the second predetermined acceleration threshold. In some embodiments, the second predetermined acceleration threshold may be equal to the first predetermined threshold.

In some embodiments, the controller 220 may use further properties of the motorized kick scooter to determine whether to control the light source 210 to enter the third intensity state, such as a pitch, a roll, a yaw, an inertial measurement unit status, a weight of a user, and/or a user input for controlling a speed of the motorized kick scooter.

For example, the controller 220 may control the light source 210 to enter the third intensity state in response to a combination of some or all of: the speed being greater than the first predetermined speed threshold; an acceleration being less than the second predetermined acceleration threshold and/or braking being applied; at least two of a non-zero pitch, a non-zero roll and/or a non-zero yaw; an inertial measurement unit status indicating that the scooter is vertical; a weight of a user being present on the motorized kick scooter; and information responsive to a user input indicating that a user input for controlling the speed of the motorized kick scooter was most recently switched on. Suitable combinations of these properties for determining that the third intensity state is the desired intensity state will be apparent to the skilled person.

In some embodiments, the at least three light intensity states may comprise a fourth intensity state, in which the light source 210 emits light of a fourth intensity, greater than the first intensity and lower than the second intensity.

In some embodiments, the at least three light intensity states may comprise the first intensity state, the second intensity state, the third intensity state and the fourth intensity state. In other embodiments, the at least three light intensity states may comprise the first intensity state, the second intensity state and the third intensity state, but not the fourth intensity state. In yet other embodiments, the at least three light intensity states may comprise the first intensity state, the second intensity state and the fourth intensity state, but not the third intensity state.

The controller 220 may control the light source 210 to enter the fourth intensity state based on the one or more properties of the motorized kick scooter indicating that a rider of the scooter is about to start a journey, for example, that the rider has kick-started the scooter but has yet to press the throttle, or that the rider has just finished a journey, for example, that the scooter is stationary and that the rider is about to dismount. In these situations, it may still be useful to illuminate the rider and/or scooter (e.g. to increase a visibility to other vehicles. Providing low intensity light allows the rider and/or scooter to be seen by other vehicles while minimizing the risk of the rider being dazzled by the light (as they may not be facing the direction of travel).

An indication that a rider is about to start a journey may be obtained, for example, using information responsive to a speed of the kick scooter and/or whether the throttle has been operated and so on.

An indication that a rider of the scooter has kick-started the motorized kick scooter but has yet to press the throttle may comprise, for example, detecting that a speed of the motorized kick scooter is greater than a second predetermined speed threshold, and that no user input for controlling a speed of the motorized kick scooter has been received since a time at which the motorized kick scooter was most recently switched on.

The second predetermined speed threshold may be used to distinguish between a motorized kick scooter that has been kick-started and a motorized kick scooter that is being rolled along by a user who is walking alongside the scooter. A user of the motorized kick scooter is more likely to face more fully the light projected from the light source 210 when rolling the scooter along than when kick-starting the scooter, and therefore more likely to be dazzled by any projected light; it may therefore be desirable to control the light source 210 to operate in the first intensity state when the user is rolling the scooter along.

The second predetermined speed threshold may therefore be a value between a typical walking speed and a typical speed of a kick-started scooter. For example, the second predetermined speed threshold may be any value between 3.5 mph and 5 mph. In some embodiments, the second predetermined speed threshold may be greater than the first predetermined speed threshold. In other embodiments, the second predetermined speed threshold may be equal to the first predetermined speed threshold.

An indication that the motorized kick scooter is stationary and that the rider is about to dismount may comprise, for example, detecting that a speed of the motorized kick scooter is not greater than the first predetermined speed threshold, that no braking is applied, and that a user input for controlling a speed of the motorized kick scooter has been received since a time at which the motorized kick scooter was most recently switched on.

A user input for controlling a speed of the motorized kick scooter having been received since a time at which the motorized kick scooter was most recently switched on indicates that the scooter has started a journey, while a speed no greater than the first predetermined speed threshold and no braking being applied may indicate that the motorized kick scooter is stationary and that the rider is ready to dismount.

The expected sensor inputs for a motorized kick scooter in each of the above described situations and the resultant light intensity state of the light source 210 are summarized in Table 1.

Table 1 shows the resultant light intensity state for a light source operable in the first, second, third and fourth intensity states. A light source operable in only the first, second and third intensity states may be controlled to operate in the first intensity state where the light source operable in all four intensity states is controlled to operate in the fourth intensity state. A light source operable in only the first, second and fourth intensity states may be controlled to operate in the second intensity state where the light source operable in all four intensity states is controlled to operate in the third intensity state.

In some situations, not all sensor inputs need be considered in order to determine a desired light intensity state. For example, if the light projection system of the scooter is switched on, but the motorized kick scooter is switched off, the controller may control the light source to operate in the first intensity state based only on an on/off state of the motorized kick scooter. In Table 1, sensor inputs that are not relevant for determining a desired light intensity state in a particular situation are indicated using dashes in the row representing the sensor inputs for that situation.

As can be seen from Table 1, pitch, roll and yaw, may not provide information that further distinguishes between situations when combined with the remaining sensor inputs. These inputs may therefore be considered optional for use in determining a desired light intensity state. Rather, these inputs may be considered to serve as an indicator that the scooter is moving (i.e. should not be in a zero light intensity state).

FIG. 3 illustrates a speed-time graph 300 of a motorized kick scooter for an example journey. The motorized kick scooter comprises an embodiment of the light projection system 200, wherein the light projection system comprises first, second, third and fourth intensity states. In the first intensity state, the light source 210 emits no light (off); in the second intensity state, the light source 210 emits medium intensity (normal) light; in the third intensity state, the light source 210 emits high intensity (bright) light; and in the fourth intensity state, the light source 210 emits low intensity (dim) light.

The speed-time graph starts at time 301. The first predetermined speed threshold 320 and second predetermined speed threshold 330 used by the controller 220 to determine which light intensity state to control the light source 210 to operate in, as described above, are shown on the speed-time graph 300. In this example, the first predetermined speed threshold 320 is zero.

At time 301, the motorized kick scooter is being rolled along by a rider of the motorized kick scooter walking alongside the scooter. The motorized kick scooter has been switched on, but a user input for controlling a speed of the motorized kick scooter has not been received since the scooter was switched on. The speed of the motorized kick scooter is below the second predetermined speed threshold 330. Based on at least these properties, the controller 220 controls the light source 210 to operate in the first intensity (off) state between time 301 and time 302, in order that the rider is not dazzled by projected light while rolling the scooter along.

At time 302, the rider stops rolling the motorized kick scooter along in order to mount the scooter. A user input for controlling a speed of the motorized kick scooter has still not been received since the scooter was switched on, and the speed of the motorized kick scooter is still below the second predetermined speed threshold 330. Based on at least these properties, the controller 220 controls the light source 210 to continue to operate in the first intensity (off) state between time 302 and time 303, in order that the rider is not dazzled by projected light while mounting the scooter.

At time 303, the rider kick-starts the scooter. A user input for controlling a speed of the motorized kick scooter has still not been received since the scooter was switched on, but the speed of the motorized kick scooter now exceeds the second predetermined speed threshold 330. Based on at least these properties, the controller 220 controls the light source 210 to enter the fourth intensity (dim) state at time 303. This dim state may increase a visibility of the allowing the rider and/or scooter (to other vehicles) but may not be sufficiently bright to dazzle the rider (e.g. if they intend to quickly dismount the scooter).

At time 304, the rider presses a throttle of the motorized kick scooter. This action corresponds to receiving a user input for controlling a speed of the motorized kick scooter. The speed of the motorized kick scooter exceeds the first predetermined speed 320 and no braking is applied. The speed of the motorized kick scooter varies slightly between time 304 and time 305, but the acceleration is always greater than a first predetermined (negative) acceleration threshold. Based on at least these properties, the controller 220 controls the light source 210 to enter the second intensity (normal) state at time 304, making the motorized kick scooter and rider easily visible to other road users.

At time 305, the rider presses a brake lever of the motorized kick scooter in order to stop the motorized kick scooter. The motorized kick scooter begins to decelerate, and the acceleration of the motorized kick scooter is less than a second predetermined (negative) acceleration threshold. The speed of the motorized kick scooter remains greater than the first predetermined speed threshold 320 between time 305 and time 306. Based on at least these properties, the controller 220 controls the light source 210 to enter the third intensity (bright) state at time 305, alerting other road users to the motorized kick scooter’s reduction in speed.

At time 306, the motorized kick scooter stops, and remains stationary between time 306 and time 307. The speed of the motorized kick scooter is not greater than the first predetermined speed threshold 320. The rider is still applying the braking, and a user input for controlling a speed of the motorized kick scooter has been received since the scooter was last switched on. Based on at least these properties, the controller 220 controls the light source 210 to enter the second intensity (normal) state at time 306, allowing the motorized kick scooter and rider to remain visible to other road users while the motorized kick scooter is stationary.

At time 307, the rider kick-starts the motorized kick scooter again. Unlike the kick-start at time 303, a user input for controlling a speed of the motorized kick scooter has now been received since the scooter was last switched on. The speed of the motorized kick scooter is once more greater than the first predetermined speed threshold 320. Once the motorized kick scooter has reached its maximum speed from the kick, the scooter begins to decelerate slightly until power is applied to the motorized kick scooter, but the acceleration is greater than the first predetermined (negative) acceleration threshold. Based on at least these properties, the controller 220 controls the light source 210 to continue to operate in the second intensity (normal) state between time 307 and time 308.

At time 308, the rider presses the throttle of the motorized kick scooter. The speed of the motorized kick scooter is still above the first predetermined speed threshold 320, and the acceleration is greater than the first predetermined (negative) acceleration threshold. Based on at least these properties, the controller 220 controls the light source 210 to continue to operate in the second intensity (normal) state between time 308 and time 309.

At time 309, the rider presses the brake lever of the motorized kick scooter in order to stop the motorized kick scooter again. The motorized kick scooter begins to decelerate, and the acceleration of the motorized kick scooter is less than the second predetermined (negative) acceleration threshold. The speed of the motorized kick scooter remains greater than the first predetermined speed threshold 320 between time 309 and time 310. Based on at least these properties, the controller 220 controls the light source 210 to enter the third intensity (bright) state at time 309.

At time 310, the motorized kick scooter stops again, and this time remains stationary: the rider has finished their journey. The speed of the motorized kick scooter is no greater than the first predetermined speed threshold 320, and a user input for controlling a speed of the motorized kick scooter has been received since the scooter was last switched on. At time 310, the rider is still applying the braking. Based on at least these properties, the controller 220 controls the light source 210 to enter the second intensity (normal) state at time 310.

At time 311, the rider releases the brake lever, ready to dismount the scooter. The speed is still no greater than the first predetermined speed threshold 320, and a user input for controlling a speed of the motorized kick scooter has been received since the scooter was last switched on. Based on at least these properties, the controller 220 controls the light source 210 to enter the fourth intensity (dim) state at time 311, illuminating the rider and/or scooter (to increase their visibility), but not bright enough to risk dazzling the rider as they dismount.

The controller 220 may control the light source 210 to enter the first intensity (off) state in response to the motorized kick scooter being switched off or no user input being received for a period of time. Alternatively, switching the scooter off may also switch off the light projection system 200.

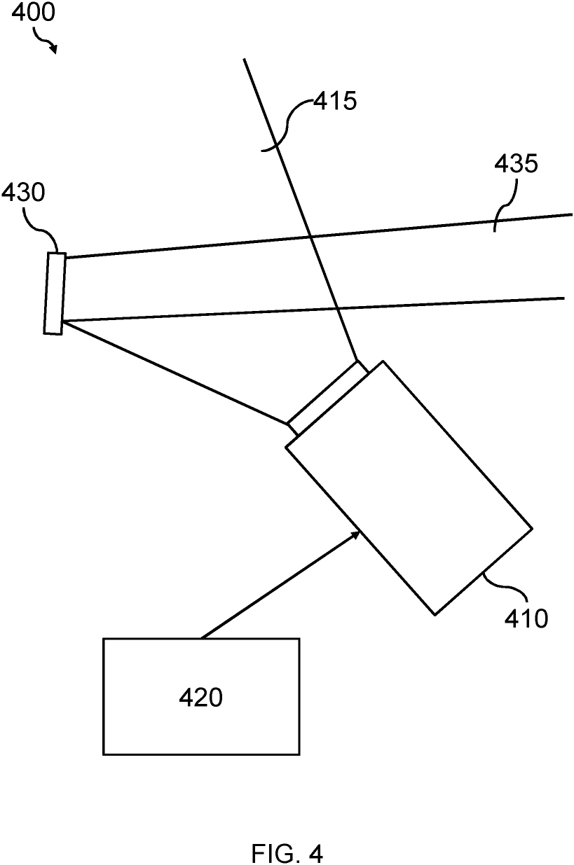

FIG. 4 illustrates a light projection system 400 for a motorized scooter, comprising a light source 410, a controller 420 and a reflector 430, according to an embodiment of the invention.

The light source 410 projects light 415 for illuminating a rider of a motorized kick scooter with an intensity controlled by the controller 420, as previously described. A portion of the light 415 projected by the light source 410 is incident on a reflective surface of the reflector 430 and is redirected as reflected beam 435. This allows some of the light 415 from the light source 410 to be directed away from the rider of the motorized kick scooter, providing, for example, a rear-facing beam for long range visibility.

The reflector 430 may be angled with respect to the light source 410 such that the reflected beam 435 is horizontal, or near horizontal, for example, within 20° of horizontal. Suitable angles for the reflector 430 with respect to the light source 410 in order that the reflected beam 435 is horizontal or near horizontal will depend on the position of the light source 410 on the motorized kick scooter, and will be apparent to the skilled person.

For the sake of completeness, it is noted that in any above-described intensity state, the light output by the light source may be constant and/or flashing (depending upon an operation mode). Thus, the controller may further control whether the light output by the light source is constant or flashing.

Any herein identified predetermined acceleration threshold may be dependent upon a speed of the motorized cycle. In particular, the magnitude of the predetermined acceleration threshold may increase in response to an increase in the speed of the motorized cycle. This embodiment takes into account how a change in acceleration is less perceptible at high speeds, than at low speeds, to provide a more intuitive indication of the rider’s speed to other vehicles.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. Any reference signs in the claims should not be construed as limiting the scope.

TABLE 1

| intensity state | expected sensor inputs of motorized kick scooter | | | | | |
|---|---|---|---|---|---|---|
| | on/off state | user input for controlling speed | speed | braking | acceleration | pitch/roll/yaw |
| first | off | --- | - | - | - | - |
| | on | not received for first predetermined period of time | not greater than second threshold | - | - | - |
| second | on | received since scooter switched on | greater than first threshold | not applied | greater than first threshold | at least two are non-zero |
| | on | received since scooter switched on | not greater than first threshold | applied | - | - |
| third | on | received since scooter switched on | greater than first threshold | applied | less than second threshold | at least two are non-zero |
| | on | received since scooter switched on | greater than first threshold | applied | not less than second threshold | at least two are non-zero |
| | on | received since scooter switched on | greater than first threshold | not applied | less than second threshold | at least two are non-zero |
| fourth | on | not received since scooter switched on | greater than second threshold | - | - | - |
| | on | received since scooter switched on | not greater than first threshold | not applied | - | - |

1. A light projection system for a motorized kick scooter, comprising:
a light source configured to project light for illuminating a rider of the motorized kick scooter and operable in at least three different light intensity states, wherein the at least three light intensity states comprise:
a first intensity state, in which the light source is configured to emit light of a first intensity; and
a second intensity state, in which the light source is configured to emit light of a second, greater intensity; and
a controller configured to control in which of the at least three light intensity states the light source operates based on one or more properties of the motorized kick scooter.

2. The light projection system of claim 1, wherein the one or more properties of the motorized kick scooter are properties that are responsive to a user interaction with the motorized kick scooter.

3. The light projection system of claim 2, wherein the one or more properties of the motorized kick scooter include at least one of: a speed; a pitch; a roll; a yaw; a braking; an acceleration; a deceleration; an inertial measurement unit status; a weight of a user on the motorized kick scooter; an on/off state; and/or information responsive to a user input for controlling a speed of the motorized kick scooter.

4. The light projection system of claim 1, wherein the controller is configured to receive sensor data from one or more sensors that monitor the motorized kick scooter, the sensor data providing information on the one or more properties of the motorized kick scooter.

5. The light projection system of claim 1, wherein the controller is configured to control the light source to enter the first intensity state based on an indication from the one or more properties of the motorized kick scooter that a user is not mounted on and/or riding the motorized kick scooter.

6. The light projection system of claim 1, wherein:
the one or more properties of the motorized kick scooter include an on/off state of the motorized kick scooter;
the controller is configured to control the light source to enter the first intensity state in response to the motorized kick scooter being in an off state; and
the controller is configured to keep the light source in the first intensity state in response to the motorized kick scooter being switched from an off state to an on state.

7. The light projection system of claim 6, wherein:
the one or more properties of the motorized kick scooter include information responsive to a user input for controlling a speed of the motorized kick scooter; and
the controller is configured to keep the light source in the first intensity state in response to the information responsive to a user input indicating that no user input for controlling a speed of the motorized kick scooter has been received since a time at which the motorized kick scooter was most recently switched on.

8. The light projection system of claim 1, wherein:
the one or more properties of the motorized kick scooter include a speed; a braking and an acceleration of the motorized kick scooter; and
the controller is configured to control the light source to enter the second intensity state in response to:
information responsive to a user input indicating that a user input for controlling the speed of the motorized kick scooter has been received since a time at which the motorized kick scooter was most recently switched on;
the speed being greater than a first predetermined speed threshold; and
the acceleration being greater than a first predetermined acceleration threshold; and/or no braking being applied.

9. The light projection system of claim 1, wherein:
the one or more properties of the motorized kick scooter include information responsive to a user input for controlling a speed of the motorized kick scooter, and a speed and a braking of the motorized kick scooter; and
the controller is configured to control the light source to enter the second intensity state in response to:
a speed being no greater than a first predetermined speed threshold;
braking being applied; and
the information responsive to a user input indicating that a user input for controlling the speed of the motorized kick scooter has been received since a time at which the motorized kick scooter was most recently switched on.

10. The light projection system of claim 1, wherein the at least three light intensity states comprise:
a third intensity state, in which the light source is configured to emit light of a third intensity, wherein the third intensity is greater than the second intensity.

11. The light projection system of claim 10, wherein:
the one or more properties of the motorized kick scooter include a speed of the motorized kick scooter, and an acceleration and/or a braking of the motorized kick scooter; and
the controller is configured to control the light source to enter the third intensity state in response to:
a speed being greater than a first predetermined speed threshold; and
an acceleration being less than a second predetermined acceleration threshold and/or braking being applied.

12. The light projection system of claim 1, wherein the at least three light intensity states comprise:
a fourth intensity state, in which the light source is configured to emit light of a fourth intensity, the fourth intensity being greater than the first intensity and lower than the second intensity.

13. The light projection system of claim 12, wherein:
the one or more properties of the motorized kick scooter include a speed of the motorized kick scooter and information responsive to a user input for controlling a speed of the motorized kick scooter; and
the controller is configured to control the light source to enter the fourth intensity state in response to:
the speed being greater than a second predetermined speed threshold; and
the information responsive to a user input indicating that no user input for controlling a speed of the motorized kick scooter has been received since a time at which the motorized kick scooter was most recently switched on.

14. The light projection system of claim 12, wherein:
the one or more properties of the motorized kick scooter include information responsive to a user input for controlling a speed of the motorized kick scooter, and a speed and a braking of the motorized kick scooter; and
the controller is configured to control the light source to enter the fourth intensity state in response to:
the speed being no greater than a first predetermined speed threshold;
no braking being applied; and
the information responsive to a user input indicating that a user input for controlling a speed of the motorized kick scooter has been received since a time at which the motorized kick scooter was most recently switched on.

15. The light projection system of claim 1, further comprising:
a reflector configured to reflect a portion of light emitted by the light source away from a rider of the motorized kick scooter.

16. A motorized kick scooter, comprising the light projection system of claim 1.

17. The motorized kick scooter of claim 16, wherein the light source is positioned to illuminate a rear of a rider of the motorized kick scooter.
